(19) United States
(12) Patent Application Publication
(10) Pub. No.: US 2014/0188618 A1
(43) Pub. Date: Jul. 3, 2014

(54) SYSTEM AND METHOD FOR CONNECTING PEOPLE IN RELATION TO A DIRECTORY AND DELIVERING A TARGETED MESSAGE

(71) Applicant: PHILIPPE PENIDE, LUXEMBOURG (DE)

(72) Inventor: PHILIPPE PENIDE, LUXEMBOURG (DE)

(21) Appl. No.: 13/733,169

(22) Filed: Jan. 3, 2013

(51) Int. Cl. G06Q 30/02

(52) U.S. Cl. CPC G06Q 30/0269
USPC 705/14.58; 705/14.66

(57) ABSTRACT

A system and method for connecting a user to an entity in relation to one or more directories comprising one or more databases, said databases comprising one or more contact information of one or more entities replaced by one or more intermediate contact information provided by an intermediate system, said intermediate system receiving the contact of the user made to the intermediate contact, delivering a targeted message to the user before routing the user to the entity.

### FIELD OF TECHNOLOGY

The following relates to a method and a system for connecting people in relation to a directory database, said method and system comprising the delivery of a relevant and targeted message according to a particular context.

### BACKGROUND

A directory generally comprises organized data and provides a support to search any type of information. For example, the telephone directory, in the paper form or electronic form, allows telephone numbers to be found given the individuals and organizations name, while a web directory provides an organized collection of links to websites in response to search requests.

Advertising directories are also well known. In such directories, advertisements are classified according to some purpose. The most commonly known directory is the hard copy or web form of the Yellow Pages which comprises information about potential providers of goods and services, but advertising directories may be also found in newspapers, regional dailies, weekly papers, technical and professional magazines.

Consumer to consumer, or peer-to-peer, directories are also well known. They facilitate the sale or transfer of goods and services between individuals using a third party providing a website or a paper copy of the offers to match consumers.

Generally, a user consults a hard copy or an electronic directory, of any kind discussed above, to get the information and contact information, for example a telephone number, he is interested in, and contacts the entity, individual, organisation or business, of interest, generally by placing a telephone call to the telephone number of said entity.

One main drawback of this way to proceed is that generally the contact information, i.e. telephone numbers, are the real contact information, i.e. telephone numbers, of the entity to reach, leading to a lack of privacy, especially for unlisted numbers, or silent lines, of individuals posting an advertisement in a peer-to-peer directory. Furthermore, real telephone numbers published in a directory of any kind are generally a target of choice for unwelcome communications, unsolicited communications or unwanted telemarketing calls.

Another main drawback is that the charges of a telephone call to reach an entity, corresponding to a local or long distance call, to a local or national number, or to a pay-per-call or premium-rate telephone number, is generally supported by the person who call, unless the called number is a toll-free or free call number (800, 0800 or 1-800 number), in this case the charges are supported by the called party.

In addition, it is well known that methods and/or systems to connect people usually allow the delivery of advertisements, but generally such advertisements are not automatically activated or delivered. Furthermore such advertisements generally do not match the people's desire or needs, leading to a waste of money for the advertiser, and leading to a bad brand image for the advertiser.

### SUMMARY

Aspects of this disclosure relate to providing a system and a method which do not have the drawbacks of the prior art, which can provide a way to increase entity privacy for information accessed in directories. A further aspect provides a system and a method which provide an alternative solution to the Do-Not-Call Registry.

Another aspect provides a system and a method which provide an alternative solution to the toll-free telephone numbers or pay-per-call or premium-rate telephone numbers.

Another aspect provides a system and a method to deliver automatically a message.

Yet another aspect provides a system and a method providing a way to increase relevancy of delivered messages. The invention relates to a system and a method for connecting people, at least two entities or individuals, a user and a provider, in relation to a directory.

The system according to the invention comprises one or more directories comprising one or more databases, the databases comprising one or more contact information of one or more entities, and an intermediate system comprising means for storing one or more messages from one or more promoters, switching means for replacing the contact information with one or more intermediate contact information, tracking means for making the link between the contact information and the one or more intermediate contact information, a receiving unit to receive a contact from the user using the intermediate contact information, information collecting means for collecting one or more parameters of the user, one or more information comprised in the databases, one or more parameters of the entities to be reached and a combination thereof, selecting means for selecting one or more message from one or more promoters, the selecting means being adapted to select the one or more messages according to the relevancy of the messages with the criteria formed by the parameters and/or information collected by the information collecting means, means for delivering the selected one or more messages to the user, routing means to route the user to said one or more entities, network means connected to the receiving unit and to the routing means, a user interface allowing the user to access the intermediate contact information provided by the intermediate system.

According to particular embodiments, the system may comprise one, or a combination, of any of the following characteristics:
the switching means replace the contact information of the one or more entities according to the geographic location of the user,
the selecting means are adapted to determine the relevancy of the one or more messages from the one or more promoters by generating a score for said messages, one point being given if at least one criteria formed by the parameters and/or information collected by the information collecting means is met, one point for each further criterion met, and further financial points, the financial point being calculated in respect to the expected financial incomes provided by the messages,
the means, for delivering the selected one or more messages to the user, deliver the one or more messages having the highest score or having the highest number of financial points,
the routing means of the intermediate system route the user to the one or more promoters for which the selected one or more message have been delivered, using contact information provided by the one or more promoters,
the intermediate system further comprises means for tracking the number of contact received using the intermediate contact information and/or the number of message delivered to the user and means for billing the one or more promoter for the costs for the connection of the user with the one or more entities,
the intermediate system further comprises means for the one or more promoters to upload or create the message,
the one or more contact information is one or more telephone number,
the system further comprises an Interactive Voice Server.

The method according to the invention comprises the steps of providing one or more directory systems comprising one or more directory databases, the databases comprising one or more contact information of one or more entities, replacing the one or more contact information with one or more intermediate contact information provided by an intermediate system, tracking the link between the one or more contact information and the one or more intermediate contact information, enabling the user to access to the one or more intermediate contact information, receiving a contact from the user using the intermediate contact information, collecting one or more parameters of the user, one or more information comprised in the databases, one or more parameters of the one or more entities to be reached and a combination thereof, providing one or more messages from one or more promoters, selecting one or more messages to deliver from the messages from the promoters according to the relevancy of the messages with the criteria formed by the parameters and/or information collected by the information collecting means, delivering to the user the one or more messages selected, routing the user to the one or more entities using the contact information of the one or more entities.

According to particular embodiments, the method may comprise one, or a combination, of any of the following characteristics:
the method further comprises the steps of determining the geographic location of the user and selecting or generating an intermediate contact information according to said geographic location of said user,
the relevancy of the one or more messages from the one or more promoters is determined by generating a score for the messages, one point being given if at least one criteria formed by the parameters and/or information collected by the information collecting means is met, one point for each further criterion met, and further financial points, the financial point being calculated in respect to the expected financial incomes provided by the messages,
delivering one or more messages having the highest score or having the highest number of financial points,
the method further comprises the step of routing the user to the one or more promoters for which the selected one or more messages has been delivered, using contact information provided by the one or more promoter,
the method further comprises the steps of tracking the number of contact received using the intermediate contact information and/or the number of message delivered to the user and billing the one or more promoter for the costs for the connection of the user with the one or more entities,
the method further comprises a step wherein the one or more promoters upload or create one or more messages,
the one or more contact information of one or more entities is a telephone number,
the method uses an Interactive Voice Server.

### DETAILED DESCRIPTION

The system according to the invention comprises at least one, preferably a plurality of directory systems, said directory system comprising a directory database or a plurality of databases. Preferably said directory system or systems are in a paper form or electronic form.

The database or a plurality of databases comprises at least one contact information of at least one entity, for example a public or private company, organisations, people and/or websites. Preferably, the at least one contact information is a telephone number or mobile phone number. The database or a plurality of databases may further comprise any further information about goods and/or services provided by said entity.

The system according to the invention further comprises an intermediate system comprising switching means replacing the real contact information of the one or more entities present in the database or databases of the directory or directories with at least one intermediate contact information provided by the intermediate system. Preferably, the switching means replace the real telephone number, or mobile phone number, of the entities by one or more telephone numbers of the intermediate system.

Preferably, the one or more intermediate contact information provided by the intermediate system are unique for a given entity. Once provided and assigned it is disabled for a new assignment for another entity until the intermediate has received a request to do so for any reason, for example because the entities has being removed from the directory, or because the entities want to publish their real contact information. The intermediate contact information are then enabled for a new assignment to another entity of the directory or directories.

The switching means may comprise a physical person assigning and replacing manually, or by means of a computer, the contact information of the entity in the database, but preferably the switching means comprise computer means to automatically assign and replace the entity contact information. It may comprise any suitable hardware, software and/or firmware.

Preferably, the intermediate system comprises means for selecting or generating an intermediate contact information, for example an intermediate telephone number, according to the geographic location of the user.

The intermediate system comprises tracking means for making the link between the real contact information, for example the telephone number, of the one or more entities to be reached and the intermediate contact information, for example a telephone number, provided to said entities.

The intermediate system comprises receiving unit to receive a contact from a user using the intermediate contact information, for example to receive an incoming call placed to the intermediate telephone numbers provided by the intermediate system.

The intermediate system comprises information collecting means to collect one or more parameters of the user, to collect one or more information comprised in the one or more directory databases of the one or more directory systems and/or one or more parameters of the one or more entities to be reached.

The one or more parameters of the user are the geographic location of the user, the type of device used to contact the entity, e.g. telephone, computer, television, and/or the type of query or queries made in the directory, e.g. type and/or nature of the goods or services requested, and/or the time and/or date on which the user contacts the entity and/or the number and the entity type of previous contacts placed by the user.

The one or more information comprised in the one or more directory databases are the directory type, e.g. advertising directory, consumer to consumer directory etc, the directory nature, e.g. website or paper copy etc, the type of contact information used, e.g. telephone number etc, and/or the type of goods and/or services in the directory, e.g. category of goods such as car, real-estate, category of services such as car or home rental etc.

The one or more parameters of the entity to be reached are the entity type, e.g. private, business, non-profit organisation, government etc, and/or the geographic location of the entity, and/or the goods and/or services provided by the entity to be reached.

The intermediate system comprises means for selecting a message to be delivered to the user contacting the entity, for example the user placing a call to the intermediate telephone number.

The means for selecting the message to be delivered select the message according to the relevancy, or degree of match, of the message with the criteria formed by the one or more parameters of the user, the one or more information comprised in the directory databases, the one or more parameters of the entity to be reached, collected by the information collecting means, and a combination thereof.

Preferably, the message is selected according to the geographical location of the user and of the entity to be reach and according to the type of goods and/or services in the directories.

The relevancy of the message is determined by generating a score to the messages in respect to the parameters and/or information collected by the information collecting means. The messages score one point if they match, or match approximately, at least one criterion and one supplementary point for each criterion who matches. The messages further score one point if there is no active constraint with the messages. An active constrain may be for example a specific time slot within which a message has to be delivered. Preferably, the messages score further points (called financial points) calculated in respect to the expected financial incomes, e.g. one profit unit (one cent for example) provides one point. The selection of the messages is made as the following: If only one message has a highest score, then said message is selected; if at least two messages have the highest score, then the message having the highest financial points is selected; if there is no message matching with the criteria, then a message is selected randomly.

The message is preferably an audio message, but it may also be a web link, a web page, a popup window, a video message, a SMS, a MMS, a form or a lead support.

Preferably, the message comprises information about the directory or directories which have been used and/or about the entity or entities to be reached and/or about the goods and/or services provided by the entity or entities to be reached and/or general information, for example weather forecasts, weather alerts, news alerts, public service announcements and/or a commercial or advertisement from an advertiser. The entity for which the message has to be delivered is called hereafter “promoter”.

The promoter can be the entity to be reached, a another entity present, or not, in the directory or directories used.

The message may be a unique message delivered to one user contacting one entity and may change from one user to another. However, it may be a unique message delivered to all users contacting one specific entity, or a message delivered to any user contacting any entity.

The intermediate system comprises means for delivering the selected message or messages to the user.

Preferably, the intermediate system comprises means for the promoter to upload, or to create, one or more messages to deliver. Preferably, said means allow integrating automatically the message or messages of the promoters into the intermediate system. Preferably, said means comprise computer means.

For an embodiment relating to telephony, the means for delivering the message or messages may comprise an Interactive Vocal Server allowing the user to interact with the intermediate system. In this embodiment, the Interactive Voice Vocal Server may also be used by the promoter or promoters to upload, or to create, the message or messages to deliver. In this case, the message or messages of the promoter or promoters are automatically used by the intermediate system without human interaction.

The intermediate system comprises routing means to automatically route the user to the entity or entities to be reached using the real contact information of said entities. For example, the routing means route the call of the user and establish a telephonic connection with the entity to be reached using the real telephone number of the entity.

Preferably, the routing means of the intermediate may also automatically route the user to the promoter or promoters for which the message or messages have been delivered after the user has reached the entity or entities to be reached or if the entity or entities to be reached were actually not reachable. For this embodiment, the message delivered could mention the possibility for the user to reach the promoter or promoters.

The intermediate system comprises network means to receive the contact from a user using the intermediate contact information and to route the user to the entity or entities to be reached using the real contact information of said entities. For example the intermediate system comprises network means to receive incoming calls placed to intermediate telephone numbers and for routing the incoming call to the entity to be reached. The network means may comprise a conventional telephone network, mobile phone network, local area network, (LAN), wide area network (WAN), voice Over IP network, internet network and a combination thereof.

The intermediate system comprises means for tracking the number of contact received using the intermediate contact information, for example, for tracking the number of calls placed to the intermediate number and/or the number of message delivered to the user.

Preferably, the intermediate system comprises means for charging the promoter or promoters for which the message or messages have been delivered to the user, the promoter being the entity to be reached or another entity present, or not, in the directory. The charges to be billed are either a flat fee or comprise the costs of the incoming contact request, telephone call, and/or of routing the user to the entity.

The system according to the invention comprises a user interface allowing an user to access the directory or directories comprising the intermediate contact information provided by the intermediate system. This user interface may comprise a paper copy of the directory or directories. Preferably, the user interface comprises an electronic form of the directory or directories, more preferably a website.

Preferably, the user interface is a telephone a cellular telephone, a digital assistant (PDA), a smart phone, a video game system, an audio/video player, a personal computer, a laptop computer, a computer terminal, a television or a connected television.

Preferably, the tracking means, receiving unit, the information collecting means, the means for selecting the message or messages to be delivered, means for delivering the selected message or messages, the routing means, the network means, the means for tracking the number of call placed to the intermediate number, the means for billing the promoter or promoters and the user interface comprise computer means comprising any suitable hardware, memory means, software and/or firmware.

The method according to the invention comprises the steps of providing one or more directory systems comprising one or more directory databases, said databases comprising one or more contact information of one or more entities, replacing one or more contact information of the one or more entities with one or more intermediate contact information provided by an intermediate system, tracking the link between the real contact information of the entity or entities to be reached and the intermediate contact information provided and enabling a user to access to said one or more intermediate contact information.

Preferably, the step of replacing the contact information of one or more entities comprises the steps of determining the geographic location of the user and selecting or generating an intermediate contact information, for example an intermediate telephone number, according said geographic location of the user.

The determination of the geographic location of the user may be performed by any suitable means, for example, by analysing the IP address or the regional parameter of the web browser of the user, or by analysing the telephone number of the entity to be reached, the user telephone number used to place a phone call the entity to be reached or any suitable information provided by the publisher of the directory.

Preferably, the one or more intermediate contact information provided by an intermediate system are unique intermediate contact information, which once allocated are disable for a new allocation to another entity.

The method according to the invention comprises the steps of receiving a contact from an user using the intermediate contact information, collecting one or more parameters of the user, one or more information comprised in the one or more directory databases of the one or more directory systems, one or more parameters of the entity to be reached, and a combination thereof, providing one or more messages from one or more promoters, selecting one or more messages to deliver from said messages from said promoters according to the relevancy of said messages with the criteria formed by the parameters and/or information collected by said information collecting means, delivering to the user the one or more messages selected, routing the user to the entity using the contact information of said entity.

The one or more parameters of the user are the geographic location of the user, the type of device used to contact the entity or entities, e.g. telephone, computer, television, and/or the type of query or queries made in the directory, e.g. type and/or nature of the goods or services requested, and/or the time and/or date on which the user contacts the entity or entities and/or the number and the entity type of previous contacts placed by the user.

The one or more information comprised in the one or more directory databases are the directory type, e.g. advertising directory, consumer to consumer directory etc, the directory nature, e.g. website or paper copy etc, the type of contact information used, e.g. telephone number etc, and/or the type of goods and/or services in the directory, e.g. category of goods such as car, real-estate, category of services such as car or home rental etc.

The one or more parameters of the entity or entities to be reached are the entity type, e.g. private, business, non-profit organisation, government etc, and/or the geographic location of the entity, and/or the goods and/or services provided by the entity to be reached.

The relevancy of the message is determined by generating a score to the messages in respect to the parameters and/or information collected by the information collecting means. The messages score one point if they match, or match approximately, at least one criterion and one supplementary point for each criterion who matches. The messages further score one point if there is no active constraint with the message. An active constrain may be for example a specific time slot within which a message has to be delivered. Preferably, the message scores further points (called financial points) calculated in respect to the expected financial incomes, e.g. one profit unit (one cent for example) provides one point.

The selection of the message is then made as the following: If only one message has a highest score, then said message is selected; if at least two messages have the highest score, then the message having the highest financial points is selected; if there is no message matching with the criteria, then a message is selected randomly.

Preferably, the message or messages delivered comprise information about the directory or directories which have been used and/or about the entity or entities to be reached and/or about the goods and/or services provided by the entity or entities to be reached and/or general information, for example weather forecasts, and/or a commercial or advertisement from one or more promoters, said promoters being the entity or entities to be reached, a another entity present, or not, in the directory or directories used.

Preferably, the message or messages delivered are unique messages delivered to one user contacting one entity and may be different from one user to another, or it may be a unique message delivered to all users contacting one specific entity, or a message delivered to any user contacting any entity.

Preferably, the message delivered is an audio message, but it may also be a web link, a web page, a popup window, a video message, a SMS, a MMS, a form or a lead support.

The method further comprise a step of routing the user to the promoter or promoters for which the message has been delivered, using any contact information provided by the promoter or promoters, after the user has reached the entity or entities to be reached or if the entity or entities were actually not reachable. For this embodiment, the message of the promoter or promoters should mention this possibility.

Preferably, the method according to the invention further comprises the step of tracking the number of contact received using the intermediate contact information and/or the number of messages delivered to the user.

Preferably, the method according to the invention further comprises the step of charging (billing) the promoter or promoters for which the message or messages have been delivered to the user, the promoter may be the entity to be reached or another entity present, or not, in the directory.

Preferably, the method according to the invention further comprises a step wherein the promoter or promoters upload or create one or more messages to deliver, preferably using means of the intermediate system, more preferably using an Interactive Vocal Server in telephony embodiments.

In a preferred embodiment, the one or more contact information comprise a telephone number, or mobile phone number, more preferably a telephone number and information about goods and/or services provided by the entity or entities.

In this embodiment, the method according to the invention comprises the steps of receiving an incoming call placed by the user to the intermediate telephone number provided by the intermediate system, selecting and delivering a targeted message to the user who placed the call, routing the call and establishing a telephonic connection with the entity to be reached using the real telephone number of the entity. Preferably, the method further comprises a step of tracking the number of calls placed to the intermediate number and/or the number of message delivered to the user and/or a step of routing the user to the promoter telephone number after the user has reached the entity to be reached or if the entity to be reached was actually not reachable. Furthermore, the step of charging the promoter for which the message has been delivered may comprise charging a flat fee or the costs of the incoming call and/or of routing the call to the entity.

The method described herein may be implemented by software programs stored on a computer-readable medium and executable by a computer system. The term “computer-readable medium” shall also include any medium that is capable of storing, encoding or carrying a set of instructions for execution by a processor or that cause a computer system to perform any step of the method disclosed.

In a preferred embodiment of the invention, a user (customer) uses an user interface, the paper copy of a directory or a computer to access a website, to search a particular product or service. After a query, the user consults a page (paper or webpage) relating to a good he is interested in and has access to the contact information, the telephone number, of the individual selling the good. The telephone number displayed is not the real telephone number of the provider of the good but a telephone number having a structure and dialing code (area code) similar or identical as the user own telephone number. The user uses a telephone, mobile phone, smartphone or computer and places a call to the telephone number displayed. The telecommunication operator of the user handles the call toward the intermediate system. The user hears than a targeted message, or advertisement, delivered by the intermediate system, informing him (if the possibility is provided), or not, that after the call with the provider of the good he can be put in contact with the promoter if he holds the line after the provider of the good has hang up. The user is then automatically redirected to the real phone number of the provider of the good.

The system and method according to the invention present the advantage of keeping secret the real contact information of goods or services provider, telephone number, avoiding unwanted telemarketing calls when the provider is not referenced any more in the directory he uses to offer goods or services. Furthermore, the intervention of a so called promoter allows putting two parties in contact free of charges for these parties, the costs being supported by the promoter.

The system and method according to the invention further present the advantage of being easy to use for the user, the entity to be reach and the promoter. It further allows the promoter to save time and costs to deliver a targeted message.

1. A system for connecting a user and one or more entities, said system comprising:
one or more directories comprising one or more databases, said databases comprising one or more contact information of one or more entities,
an intermediate system comprising:
a means for storing one or more messages from one or more promoters;
a switching means for replacing said contact information with one or more intermediate contact information;
a tracking means for making a link between said contact information and said one or more intermediate contact information;
a receiving unit to receive a contact from said user using said intermediate contact information;
an information collecting means for collecting one or more parameters of said user, one or more information comprised in said databases, one or more parameters of said entities to be reached and a combination thereof;
a selecting means for selecting one or more message from one or more promoters, said selecting means being configured to select said one or more messages according to a relevancy of said messages with a criteria formed by the parameters and/or information collected by said information collecting means;
a means for delivering the selected one or more messages to said user;
a routing means to route said user to said one or more entities;
a network means connected to said receiving unit and to said routing means; and
a user interface allowing said user to access said intermediate contact information provided by said intermediate system.

2. The system according to claim 1, wherein the switching means replaces the contact information of the one or more entities according to a geographic location of the user.

3. The system according to claims 1, wherein the selecting means is configured to determine the relevancy of the one or more messages from the one or more promoters by generating a score for said messages, one point being given if at least one criteria formed by the parameters and/or information collected by said information collecting means is met, one point for each further criterion met, and further financial points, said financial point being calculated in respect to an expected financial income provided by the messages.

4. The system according to claim 3, wherein the means for delivering the selected one or more messages to the user, delivers the one or more messages having a highest score or having a highest number of financial points.

5. The system according to claim 1, wherein the routing means of the intermediate system route the user to the one or more promoters for which the selected one or more message have been delivered, using contact information provided by said one or more promoters.

6. The system according to claim 1, wherein the intermediate system further comprises a means for tracking a number of contacts received using the intermediate contact information and/or a number of message delivered to the user and a means for billing the one or more promoter for the costs for the connection of the user with the one or more entities.

7. The system according to claim 1, wherein the intermediate system further comprises a means for the one or more promoters to upload or create the message.

8. The system according to claim 1, wherein the one or more contact information is one or more telephone number.

9. The system according to claim 1, further comprising an Interactive Voice Server.

10. A method for connecting a user and an entity comprising the steps of:
providing one or more directory systems comprising one or more directory databases, said databases comprising one or more contact information of one or more entities;
replacing said one or more contact information with one or more intermediate contact information provided by an intermediate system;
tracking a link between the one or more contact information and the one or more intermediate contact information;
enabling said user to access to said one or more intermediate contact information;
receiving a contact from said user using said intermediate contact information;
collecting one or more parameters of said user, one or more information comprised in said databases, one or more parameters of said one or more entities to be reached and a combination thereof;
providing one or more messages from one or more promoters;
selecting one or more messages to deliver from said messages from said promoters according to a relevancy of said messages with a criteria formed by the parameters and/or information collected by said information collecting means;
delivering to said user the one or more messages selected; and
routing said user to said one or more entities using the contact information of said one or more entities.

11. The method according to claim 10, further comprising the steps of determining a geographic location of the user and selecting or generating an intermediate contact information according to said geographic location of said user.

12. The method according to claims 10, wherein the relevancy of the one or more messages from the one or more promoters is determined by generating a score for said messages, one point being given if at least one criteria formed by the parameters and/or information collected by said information collecting means is met, one point for each further criterion met, and further financial points, said financial point being calculated in respect to an expected financial income provided by the messages.

13. The method according to claim 12, delivering one or more messages having a highest score or having a highest number of financial points.

14. The method according to claim 10, further comprising the step of routing the user to the one or more promoters for which the selected one or more messages has been delivered, using contact information provided by said one or more promoter.

15. The method according to claim 10, further comprising the steps of tracking a number of contact received using the intermediate contact information and/or the number of message delivered to the user and billing the one or more promoter for the costs for the connection of said user with the one or more entities.

16. The method according to claim 10, further comprising a step wherein the one or more promoters upload or create one or more messages.

17. The method according to claim 10, wherein the one or more contact information of one or more entities is a telephone number.

18. The method according to claim 10, using an Interactive Voice Server.
